(19) United States
(12) Patent Application Publication
(10) Pub. No.: US 2024/0055617 A1
(43) Pub. Date: Feb. 15, 2024

(54) BIPOLAR PLATE, ELECTROCHEMICAL CELL, AND PROCESS FOR MANUFACTURING AN ELECTROCHEMICAL CELL

(71) Applicant: Robert Bosch GmbH, Stuttgart (DE)

(72) Inventors: Andreas Ringk, Bamberg (DE); Anton Ringel, Bamberg (DE); David Thomann, Bamberg (DE); Martin Gerlach, Strullendorf (DE)

(21) Appl. No.: 18/257,963

(22) PCT Filed: Nov. 25, 2021
(86) PCT No.: PCT/EP2021/082982

§ 371 Date: Jul. 31, 2023

(30) Foreign Application Priority Data
Dec. 17, 2020 (DE) 10 2020 216 095.3

(51) Int. Cl. H01M 8/0221; H01M 8/1004

(52) U.S. Cl. CPC H01M 8/0221; H01M 8/1004; H01M 2008/1095

(57) ABSTRACT

Disclosed is a bipolar plate (20) for an electrochemical cell (100), in particular a fuel cell. The bipolar plate (20) includes at least one insert (21) used for connection to a membrane-electrode assembly (1).

### BACKGROUND

The present invention relates to a bipolar plate for an electrochemical cell, an electrochemical cell—in particular a fuel cell—and a process for manufacturing an electrochemical cell

Electrochemical cells, in particular fuel cells, having membrane electrode assemblies and bipolar plates are known in the prior art, e.g., from patent application DE102015218117 (A1). In this context, the membrane electrode assemblies typically comprise a membrane and electrode layers (optionally also diffusion layers) on both sides of the membrane. The membrane layers and the electrode layers are circumferentially surrounded by a frame structure, often referred to in this context as a subgasket.

### SUMMARY

The object of the present invention is to then provide a membrane electrode assembly and a bipolar plate, which are prevented from sliding during stacking and thus enable precise positional stacking of the individual components in a stack of cells consisting of multiple electrochemical cells.

The bipolar plate according to the invention comprises at least one insert used for a connection to a membrane electrode assembly. The insert can subsequently be connected to the membrane electrode assembly, in particular to a film of a frame structure of the membrane electrode assembly, by means of fusing or in a bonded manner. For this purpose, the insert is preferably made of a polymer, in particular a thermoplastic polymer, e.g., PEN (polyethylene naphthalate). Advantageously, the film with which the insert is fused is made of the same material as the insert itself.

In preferable embodiments, the bipolar plate comprises a roughened surface on a surface connecting to the insert. The roughened surface can, e.g., be produced by laser structuring and is used to mechanically interlock the insert into the bipolar plate for a better connection. Typically, the bipolar plate is made of metal or graphite and might only generate insufficient adhesion forces with an injection-molded insert made of a polymer insofar as said forces are generated on a relatively smooth surface. Roughening the surface, or rather contact surface, then results in significantly stronger adhesion forces being able to be formed, so that the insert is connected firmly enough to the bipolar plate.

The invention also comprises an electrochemical cell, in particular a fuel cell, having a bipolar plate and a membrane electrode unit. The bipolar plate features a design as described hereinabove. The membrane electrode assembly comprises a frame structure, the frame structure comprising a film. The film is fused to the insert of the bipolar plate, in particular connected in a bonded manner. Sufficient strength of the connection between the bipolar plate and the membrane electrode assembly is as a result achieved for the stacking process, said stacking connection being tolerated within narrow limits by means of the inventive design such that the functional surfaces of the bipolar plates and the membrane electrode assemblies can be positioned very precisely towards one another.

For this purpose, the bipolar plate and the film are preferably made of the same material, particularly preferably a thermoplastic polymer such as PEN.

In advantageous manufacturing processes, the connection between the film and the insert is produced thermally—preferably by means of a hot punch. As a result, the membrane electrode assembly can during manufacturing first be positioned towards the bipolar plate without the interference of adhesive forces. The adhesive forces are then activated or generated by means of the hot punch.

The invention thus also comprises a process for manufacturing a membrane electrode cell according to one of the embodiments hereinabove.

The process comprises the following steps:
positioning the film towards the insert.
fusing the film with the insert by means of a hot punch.

By positioning the film towards insert, the membrane electrode assembly is then positioned towards the bipolar plate, thus essentially forming an electrochemical cell. Only then are the film and the insert fused together so that the positioning can be performed without the interference of adhesion forces.

The invention also relates to further electrochemical cells, e.g., battery cells and electrolysis cells.

Further measures for improving the invention arise from the description hereinafter of several exemplary embodiments of the invention, which are schematically illustrated in the drawings. All of the features and/or advantages arising from the claims, description, or drawings, including structural details, spatial arrangements, and process steps can be essential to the invention both by themselves and in various combinations. It should be noted that the drawings are only descriptive in nature and are not intended to restrict the invention in any way.

### BRIEF DESCRIPTION OF THE DRAWINGS

Shown schematically are:

FIG. 1 a section through a fuel cell known from the prior art, whereby only the essential areas are depicted,

FIG. 2 a perspective exploded view of an electrochemical cell having a membrane electrode assembly between two bipolar plates, with only the essential areas being depicted,

FIG. 3 a membrane electrode assembly in a perspective view, with only the essential areas being depicted,

FIG. 4 a section through a membrane electrode assembly having a frame structure, with only the essential areas being depicted,

FIG. 5 a cross-sectional detail of a bipolar plate comprising an insert, with only the essential areas being depicted.

### DETAILED DESCRIPTION

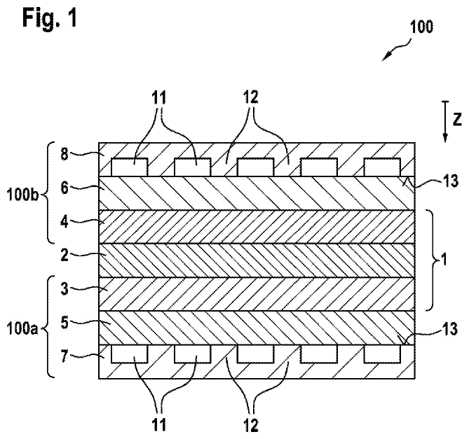

FIG. 1 schematically shows an electrochemical cell 100 from the prior art in the form of a fuel cell, with only the essential areas being depicted. The fuel cell 100 comprises a membrane 2, in particular a polymer electrolyte membrane. Designed on one side of the membrane 2 is a cathode space 100a; an anode space 100b is on the other side.

Arranged in the cathode space 100a (facing outwards from the membrane 2—i.e., in the perpendicular direction, or rather the stacking direction z) are an electrode layer 3, a diffusion layer 5, and a distributor plate 7. Arranged in a similar manner in the anode space 100b are (facing outwards from the membrane 2) an electrode layer 4, a diffusion layer 6, and a distributor plate 8. The membrane 2 and the two electrode layers 3, 4 form a membrane electrode assembly 1. Optionally, the two diffusion layers 5, 6 can also be a component of the membrane electrode assembly 1. Optionally, one or both diffusion layers 5, 6 can also be omitted insofar as the distributor plates 7, 8 are able to provide sufficiently homogeneous gas feeds.

The distributor plates 7, 8 comprise channels 11 for gas supply (e.g., of air in the cathode space 100a and hydrogen in the anode space 100b) to the diffusion layers 5, 6. The diffusion layers 5, 6 typically consist of a microporous particle layer made of carbon fiber tile on the channel side—i.e., towards the distributor plates 7, 8—and made of a microporous particle later on the electrode side—i.e., towards the electrode layers 3, 4.

The distributor plates 7, 8 comprise the channels 11 and therefore implicitly also bars 12 adjacent the channels 11. The bottoms of these bars 12 thus form a contact surface 13 of the respective distributor plate 7, 8 for the underlying diffusion layer 5, 6.

Typically, the cathode-side distributor plate 7 of an electrochemical cell 100 and the anode-side distributor plate 8 of the electrochemical cell adjacent thereto are fixedly connected, e.g., by welded connections, and thus combined into a bipolar plate 20.

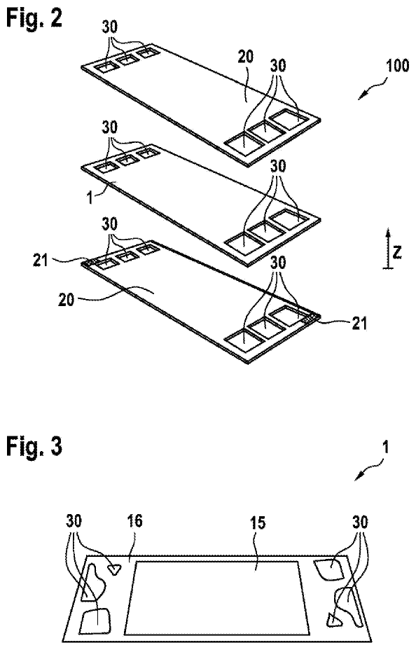

FIG. 2 schematically illustrates a perspective exploded view of the arrangement of a membrane electrode assembly 1 between two bipolar plates 20. Also visible in FIG. 2 are distributor openings 30, which are formed in the membrane electrode assembly 1, as well as in the bipolar plates 20, in the form of recesses. When the electrochemical cells 100 are stacked atop one another, the distributor openings 30 then form distributor channels in the stacking direction z, via which the individual channels 11 of the stacked electrochemical cells 100 are supplied with media. Advantageously, each membrane electrode assembly 1 and each bipolar plate 20 have a total of six distributor openings 30, i.e., one inlet and one outlet for the three media—the anode gas, the cathode gas, and the cooling medium.

Accordingly, for a cell stack consisting of several electrochemical cells 100—e.g., as many as 500—the corresponding number of membrane electrode assemblies 1 and bipolar plates 20 must be stacked alternately. The bipolar plates 20 and membrane electrode assemblies 1 must thereby be placed exactly atop one another in order to ensure the best possible overlap of their functional areas, and thus the function of the entire stack of cells. Functional areas in this context are, e.g., channels 11 and bars 12, or also the distributor openings 30 (or the seals, which are not shown).

In order to ensure positionally precise stacking without sliding when stacking the membrane electrode assemblies 1 and bipolar plates 20 to form a cell stack, the membrane electrode assembly 1 is then attached to the bipolar plate 20. This can be immediately performed while stacking the individual cells 100 to form a cell stack. Alternatively, each membrane electrode assembly 1 can be connected to a bipolar plate 20, and the resulting cells 100 can then be stacked, aligned, and compressed into a stack of cells. Strictly speaking, the term “cell” does not then relate to a single functional electrochemical cell 100 consisting of a membrane electrode assembly 1 and either half of two bipolar plates 20, but rather the connection between an entire bipolar plate 20 and a membrane electrode assembly 1.

According to the invention, the bipolar plate 20 then comprises inserts 21, in particular polymeric inserts 21, which can be integrated into the bipolar plate 20 by means of injection molding, e.g., during manufacture of the bipolar plate 20. For this purpose, the embodiment shown in FIG. 2 comprises two inserts 21 arranged diagonally on the lower bipolar plate 20, which can be connected to the overlying membrane electrode assembly 1, in particular in a bonded manner, so that a plurality of pairs, each consisting of a bipolar plate 20 and a membrane electrode assembly 1, are provided during the stacking process in order to form a cell stack. The polymeric inserts 21 can preferably be connected to a frame structure of the membrane electrode assembly 1 in a bonded manner.

FIG. 3 shows a perspective view of a membrane electrode assembly 1, with only the essential areas being depicted. The center of the membrane electrode assembly 1 comprises an active surface 15. At least the membrane 2 and the two electrode layers 3, 4—optionally also the two diffusion layers 5, 6—are arranged on said surface. The active surface 15 then cooperates with the channels 11 and the bars 12 of the distributor plates 7, 8 or the bipolar plates 20 of the electrochemical cells 100. The active surface 15 is surrounded by a frame structure 16. In the present embodiment, the frame structure 16 is designed to surround the active surface 15 along its entire circumference. Within the frame structure 16, the distributor openings 30 are designed for the media (anode gas, cathode gas, and cooling medium).

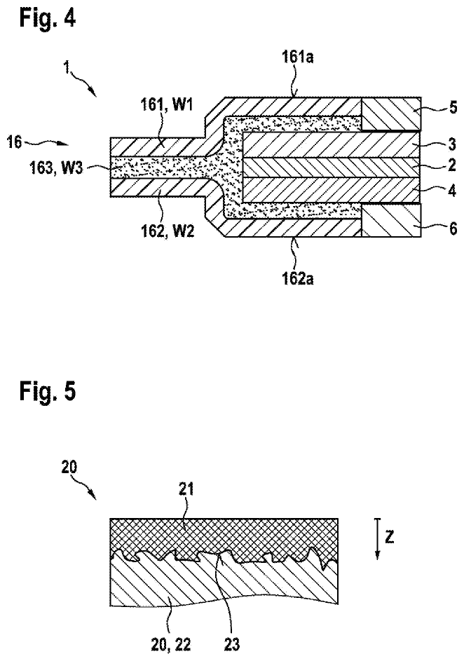

FIG. 4 shows a vertical section of the membrane electrode assembly 1 of an electrochemical cell 100, in particular a fuel cell, with only the essential areas being depicted. The membrane electrode assembly 1 comprises a membrane 2, e.g., a polymer electrolyte membrane (PEM), and two porous electrodes 3 and 4, each having a catalyst layer, in which case the electrodes 3 and 4 are each arranged on one side of the membrane 2. The electrochemical cell 100 further comprises the two diffusion layers 5 and 6 which, depending on the embodiment, can also belong to the membrane electrode assembly 1.

The membrane electrode assembly 1 is circumferentially surrounded by the frame structure 16, which in the present context is also referred to as a subgasket. The frame structure 16 is used to provide stiffness and tightness to the membrane electrode assembly 1 and is a non-active area of the electrochemical cell 100.

The frame structure 16 is in particular designed to be U-shaped or Y-shaped in section, a first leg of the U-shaped frame portion being formed by a first film 161 made of a first material W1, and a second leg of the U-shaped frame portion being formed by a second film 162 made of a second material W2. In addition, the first film 161 and the second film 162 are adhered together by means of an adhesive 163 made of a third material W3. The first material W1 and the second material W2 are often identical and made of a thermoplastic polymer, e.g., PEN (polyethylene naphthalate).

The two diffusion layers 5 or 6 are virtually inserted into the frame structure 16, conventionally such that they are each in contact with one electrode layer 3, 4 via the active surface of the electrochemical cell 100.

The first film 161 comprises a first connection surface 161a for the subsequent connection to one or multiple inserts 21 of a bipolar plate 20. In addition, the second film 162 comprises a second connection surface 162a for the subsequent connection to one or multiple inserts 21 of a further bipolar plate 20. One bipolar plate 20 is therefore connected to one respective film 161, 162 of the membrane electrode assembly 1 for the stacking process.

FIG. 5 shows a cross-sectional detail of a bipolar plate 20 according to the invention. The bipolar plate 20 comprises the insert 21, which is attached in the stacking direction z to the bipolar plate 20—i.e., to a base body 22 of the bipolar plate 20. The insert 21 can in this case be, e.g., injected onto the base body 22, or into a recess or groove of the base body 22. Preferably, the insert 21 is connected to the bipolar plate 20 or to the base body 22 by means of mechanical interlocking. The mechanical interlocking is achieved via a roughened surface 23 of the bipolar plate 20 or the base body 22. The roughened surface 23 can, e.g., be achieved by means of a surface pretreatment—preferably by means of laser structuring—and it features a relatively high degree of roughness. The insert 21 cooperates with the roughened surface 23 such that mechanical interlocks or even undercuts are created, which result in strong adhesion between the bipolar plate 20 and the insert 21.

In order to connect a bipolar plate 20 to a membrane electrode assembly 1, the bipolar plate 20 and the membrane electrode assembly 1 are therefore precisely arranged, one on top of the other, before the first film 161 or second film 162 contacting the bipolar plate 20 are locally fused in the area of the insert(s) 21, preferably by means of a hot punch, such that a bonded connection is formed between the film 161, 162 and the insert 21. The mechanical interlock between the base body 22 of the bipolar plate 20 and the insert 21 preferably ensures that the insert 21 cannot detach from the bipolar plate 20.

1. A bipolar plate (20) for an electrochemical cell (100),
wherein the bipolar plate (20) comprises at least one insert (21) configured to connect to a membrane electrode assembly (1).

2. The bipolar plate (20) according to claim 1,
wherein
the insert (21) is a polymeric insert (21).

3. The bipolar plate (20) according to claim 1,
wherein
the bipolar plate (20) comprises a roughened surface (23) on a surface connecting to the insert (21).

4. The electrochemical cell (100) having a bipolar plate (20) according to claim 1 and having a membrane electrode assembly (1), wherein the membrane electrode assembly (1) comprises a frame structure (16),
wherein the frame structure (16) comprises a film (161, 162),
wherein
the film (161, 162) is fused with the insert (21).

5. The electrochemical cell (100) according to claim 4,
wherein
the film (161, 162) and the insert (21) are made of the same material.

6. A process for manufacturing the electrochemical cell (100) according to claim 4,
wherein the bipolar plate (20) is connected to the membrane electrode assembly (1), wherein the bipolar plate (20) comprises the at least one insert (21) used for the connection to the membrane electrode assembly (1), wherein the membrane electrode assembly (1) comprises the frame structure (16) having the at least one film (161, 162),
the process comprising the following process steps:
positioning the film (161, 162) towards the insert (21), and
fusing the film (161, 162) with the insert (21) using a hot punch.

7. A bipolar plate (20) for a fuel cell (100),
wherein the bipolar plate (20) comprises at least one insert (21) configured to connect to a membrane electrode assembly (1).

8. The bipolar plate (20) according to claim 7,
wherein
the insert (21) is a polymeric insert (21).

9. The bipolar plate (20) according to claim 7,
wherein
the bipolar plate (20) comprises a roughened surface (23) on a surface connecting to the insert (21).

10. The fuel cell (100) having a bipolar plate (20) according to claim 7 and having a membrane electrode assembly (1), wherein the membrane electrode assembly (1) comprises a frame structure (16),
wherein the frame structure (16) comprises a film (161, 162),
wherein
the film (161, 162) is fused with the insert (21).

11. The fuel cell (100) according to claim 10,
wherein
the film (161, 162) and the insert (21) are both made of PEN.

12. A process for manufacturing the fuel cell (100) according to claim 11, wherein the bipolar plate (20) is connected to the membrane electrode assembly (1), wherein the bipolar plate (20) comprises the at least one insert (21) used for the connection to the membrane electrode assembly (1), wherein the membrane electrode assembly (1) comprises the frame structure (16) having the at least one film (161, 162),
the process comprising the following process steps:
positioning the film (161, 162) towards the insert (21), and
fusing the film (161, 162) with the insert (21) using a hot punch.
